(19) United States
(12) Patent Application Publication
(10) Pub. No.: US 2026/0339484 A1
(43) Pub. Date: Oct. 29, 2026

(54) ELECTRONIC DEVICE AND OPERATION METHOD THEREOF

(71) Applicant: COMPAL ELECTRONICS, INC., Taipei City (TW)

(72) Inventors: I-Hao Chen, Taipei City (TW); I-Ta Tsai, Taipei City (TW); Cheng-Hao Hsu, Taipei City (TW); Jyh-Chyang Tzou, Taipei City (TW)

(73) Assignee: COMPAL ELECTRONICS, INC., Taipei City (TW)

(21) Appl. No.: 19/651,799

(22) Filed: Apr. 20, 2026

Related U.S. Application Data
(60) Provisional application No. 63/795,608, filed on Apr. 27, 2025.

(51) Int. Cl. G06F 3/0482; G06F 3/0488; G06F 3/14

(52) U.S. Cl. CPC G06F 3/0482; G06F 3/0488; G06F 3/1446

(57) ABSTRACT

An electronic device and an operation method are provided. The operation method may include the following steps: displaying a user interface through a display of the electronic device; displaying a first menu corresponding to the user interface through a touch display of the electronic device; in response to receiving a first touch operation on the first menu by the touch display, switching the touch display to display a slider, displaying a second menu in the user interface through the display, and synchronously displaying a first extended color block through the display and the touch display, wherein the first extended color block connects the slider and the second menu; and in response to receiving a second touch operation on the slider by the touch display, moving the slider and the first extended color block.

### CROSS-REFERENCE TO RELATED APPLICATION

This application claims the priority benefit of U.S. provisional application serial no. 63/795,608, filed on Apr. 27, 2025. The entirety of the above-mentioned patent application is hereby incorporated by reference herein and made a part of this specification.

### BACKGROUND

### Technical Field

The invention relates to a device, and particularly relates to an electronic device and an operating method thereof.

### Description of Related Art

The operation of the user interface (UI) of traditional computer devices is limited to control through a mouse or keyboard on a single screen, thus having problems of poor operating experience and convenience. Moreover, as the operating functions and interface complexity of application programs increase, traditional interface operating means can no longer satisfy the user's operating experience and requirements.

### SUMMARY

The invention provides an electronic device and an operating method thereof, which may achieve good user interface operating effects through cross-screen operation design.

The operating method of the electronic device of the invention includes the following steps: displaying a user interface through a display of the electronic device; displaying a first menu corresponding to the user interface through a touch display of the electronic device; in response to receiving a first touch operation on the first menu by the touch display, switching the touch display to display a slider, displaying a second menu in the user interface through the display, and synchronously displaying a first extended color block through the display and the touch display, wherein the first extended color block connects the slider and the second menu; and in response to receiving a second touch operation on the slider by the touch display, moving the slider and the first extended color block.

The electronic device of the invention includes a first body, a second body, and a processor. The first body has a display. The second body is connected to the first body through a rotatable shaft component and has a touch display. The display and the touch display are adjacent. The processor is coupled to the display and the touch display. The processor is configured to execute the following operations: displaying a user interface through the display; displaying a first menu corresponding to the user interface through the touch display; in response to receiving a first touch operation on the first menu by the touch display, switching the touch display to display a slider, displaying a second menu in the user interface through the display, and synchronously displaying a first extended color block through the display and the touch display, wherein the first extended color block connects the slider and the second menu; and in response to receiving a second touch operation on the slider by the touch display, moving the slider and the first extended color block.

Based on the above, the electronic device and operating method thereof of the invention may display an operation assistance interface through the touch display to cooperate with the user interface displayed by the display to provide operation assistance functions, so as to achieve interface operation effects with good user experience.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a circuit block diagram of an electronic device according to an embodiment of the invention.

FIG. 2 is a device side view of an electronic device according to an embodiment of the invention.

FIG. 3 is a device top view of an electronic device according to an embodiment of the invention.

FIG. 4 is a flowchart of an operating method of an electronic device according to an embodiment of the invention.

FIGS. 5A-5E are a plurality of operation schematic diagrams of an electronic device according to an embodiment of the invention.

FIGS. 6A-6D are a plurality of operation schematic diagrams of an electronic device according to another embodiment of the invention.

### DESCRIPTION OF THE EMBODIMENTS

In order to make the content of the invention more easily understood, the following specific embodiments are provided as examples according to which the invention can indeed be implemented. In addition, wherever possible, elements/components/steps using the same reference numerals in the drawings and embodiments rethe same or similar parts.

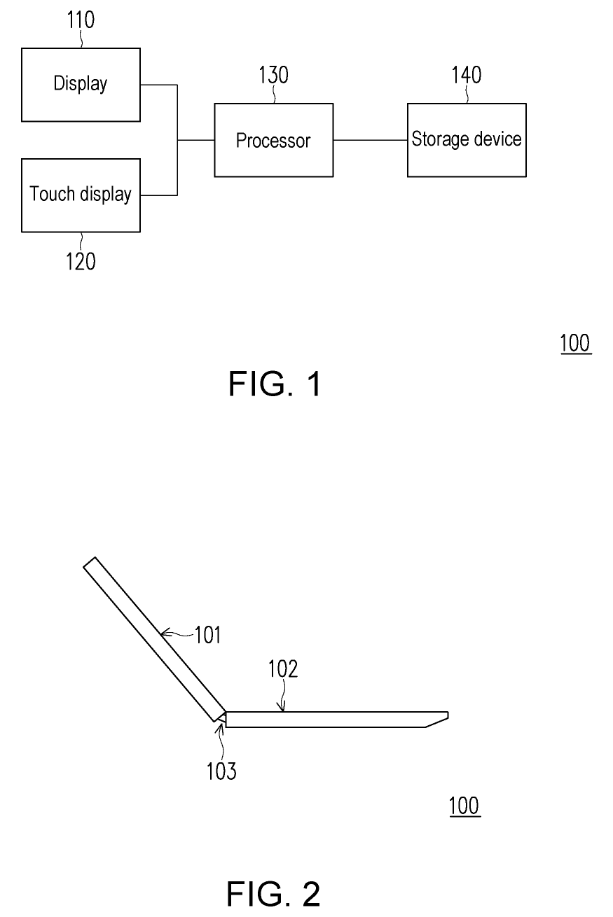

FIG. 1 is a circuit block diagram of an electronic device according to an embodiment of the invention. Referring to FIG. 1, the electronic device 100 includes a display 110, a touch display 110, a processor 130, and a storage device 140. The processor 130 is coupled to the display 110, the touch display 110, and the storage device 140. In the embodiment, the electronic device 100 may be, for example, a dual-screen laptop, a dual-screen tablet, or a dual-screen foldable phone. The display 110 and the touch display 120 are respectively disposed on different bodies of the laptop, and the display 110 and the touch display 120 are adjacent to each other. In addition, in one embodiment, the display 110 may also be a touch display.

In the embodiment, the processor 130 may include, for example, a central processing unit (CPU), an image signal processor (ISP), a microcontroller (MCU), or other programmable general-purpose or special-purpose microprocessor, a digital signal processor (DSP), a programmable controller, an application specific integrated Circuits (ASIC), a programmable logic device (PLD), other similar processing devices, or a combination of these devices.

In the embodiment, the storage device 120 may be, for example, a dynamic random access memory (DRAM), a flash memory, or a non-volatile random access memory (NVRAM), etc. In the embodiment, the storage device 120 may store an user interface, an operation assistance interfaces, a drawing software, an artificial intelligence module and/or other related programs and algorithms for implementing the various embodiments of the invention.

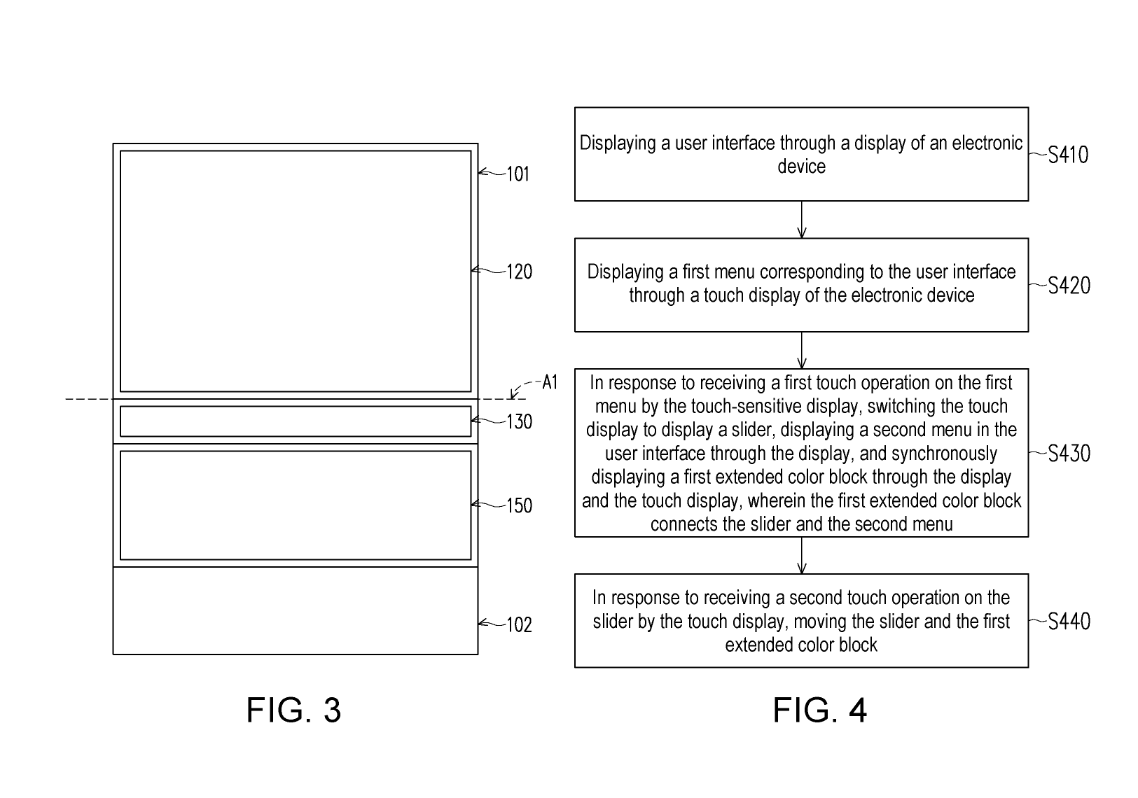

FIG. 2 is a device side view of an electronic device according to an embodiment of the invention. FIG. 3 is a device top view of an electronic device according to an embodiment of the invention. Referring to FIG. 1 to FIG. 3, the electronic device 100 further includes a first body 101, a second body 102, and a rotatable shaft component 103. The second body 102 is connected to the first body 101 through the rotatable shaft component 103, and the first body 101 may rotate relative to an axis line A1 of the rotatable shaft component 103 to operate in an open or closed state. It is worth noting that in a top view, the display 110 and the touch display 120 may cover the rotatable shaft component 103 to a seamless edge display effect.

In the embodiment, the first body 101 has the display 110, and the second body 102 has the touch display 120, but the invention is not limited thereto. In one embodiment, the display 110 and the touch display 120 may also be disposed in the first body 101. In the embodiment, the display 110 and the touch display 120 are disposed adjacent to each other, and when the first body 101 and the second body 102 are in an open state, there may be a minimal gap between the display 110 and the touch display 120, so that the user may visually regard the screens respectively displayed by the display 110 and the touch display 120 as continuous screens, but the invention is not limited thereto. In addition, the electronic device 100 may further include a keyboard module 150, and is disposed in the second body 102.

FIG. 4 is a flowchart of an operation method of an electronic device according to an embodiment of the invention. Referring to FIG. 1 to FIG. 4, the electronic device 100 may execute the following steps S410 to S440. In step S410, the display 110 of the electronic device 100 may display a user interface. In step S420, the touch display 120 of the electronic device 100 may display a first menu corresponding to the user interface. In step S430, in response to receiving a first touch operation on the first menu by the touch display 120, the touch display 120 is switched to display a slider, a second menu is displayed in the user interface through the display 110, and a first extended color block is synchronously displayed through the display 110 and the touch display 120, wherein the first extended color block connects the slider and the second menu. In step S440, in response to receiving a second touch operation on the slider by the touch display 120, the slider and the first extended color block are moved.

In the embodiment, the first menu may include a plurality of first menu icons, and the first touch operation may be a tap touch operation, wherein the tap touch operation is used to select one of the plurality of first menu icons. The touch display 120 of the invention may provide menu functionality, so that the user may operate the menu displayed by the touch display 120 through touch control, thereby achieving a convenient operation assistance effect.

In the embodiment, the second menu may include a plurality of second menu icons, and the second touch operation may be a sliding touch operation. The slider and the first extended color block may move with the sliding touch operation to selectively point to one of the plurality of second menu icons. The display 110 of the invention may display a corresponding second menu according to a selection result of the user on the first menu, and the user may select one of the plurality of second menu icons in the second menu displayed by the display 110 by moving a position of the slider through touch control. Moreover, the display 110 and the touch display 120 may synchronously display the first extended color block to show a selection result of the user using the slider to select one of the plurality of second menu icons. Therefore, the electronic device 100 and the operation method thereof according to the embodiment may effectively assist the user in understanding a correspondence relationship between dual screens, so as to reduce learning cost, and further enable mastering cross-screen operation logic.

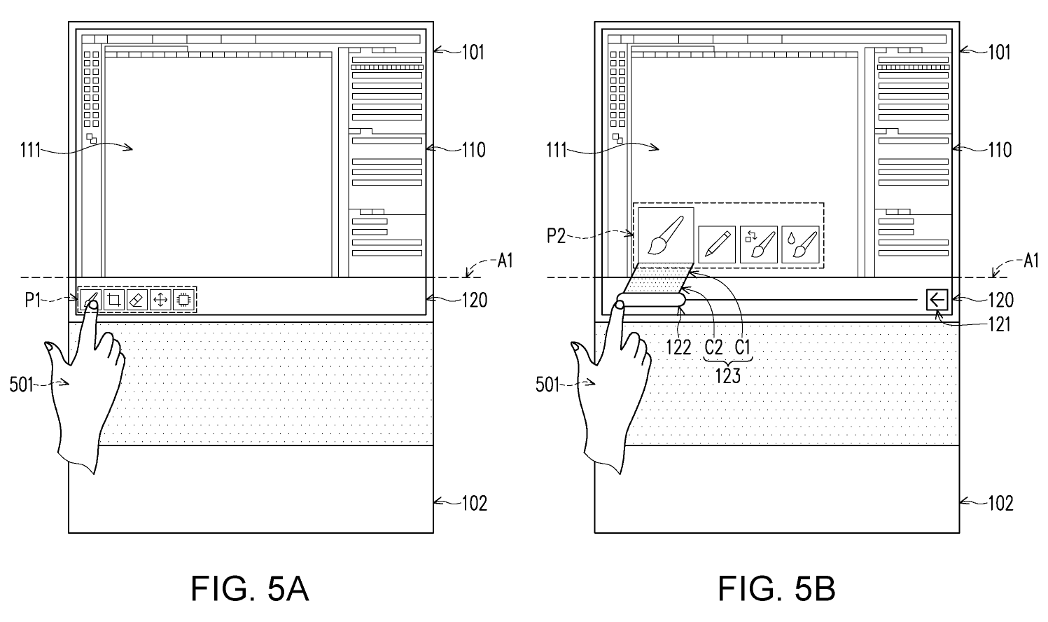

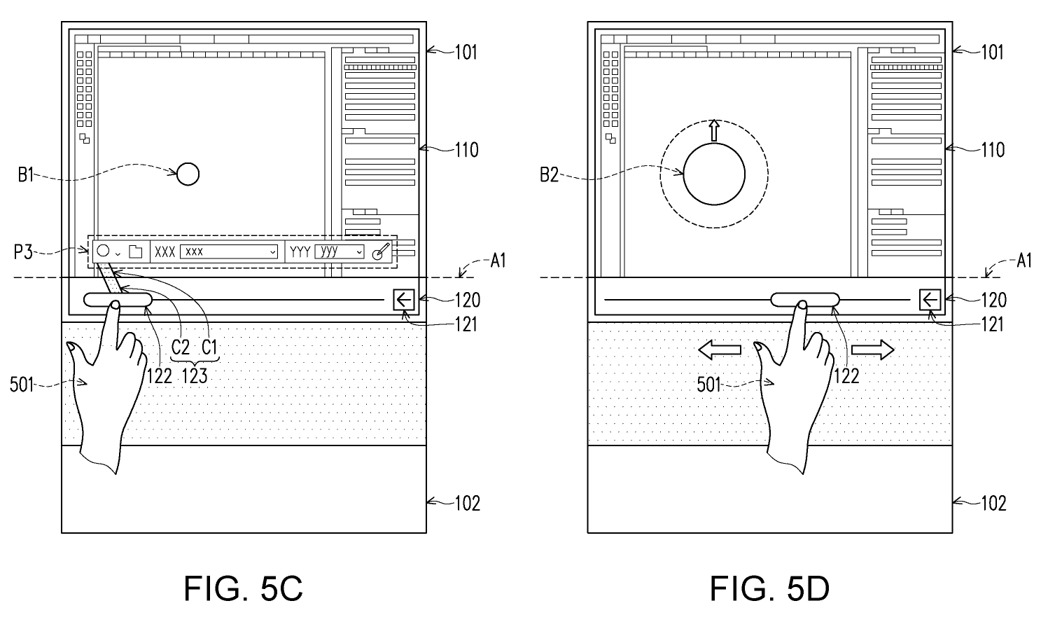

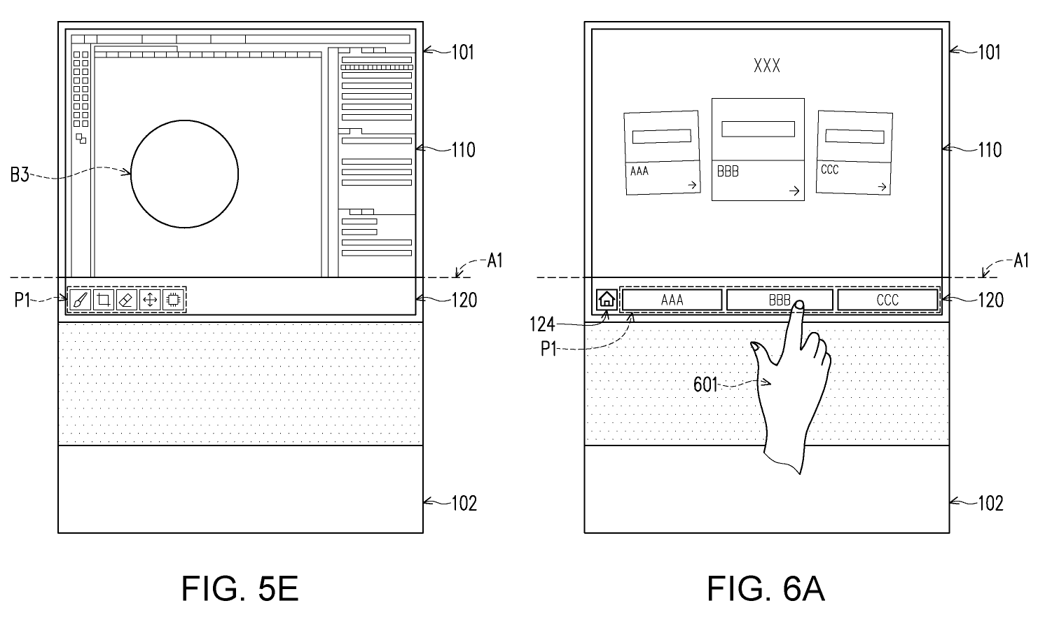

FIGS. 5A to 5E are a plurality of operation schematic diagrams of the electronic device according to the embodiment of the invention. For example, referring to FIGS. 1 and 5A - 5E, the display 110 may display the user interface 111, and the touch display 120 may display an operation assistance interface. In the embodiment, the user interface 111 may be, for example, a drawing software work page. In FIG. 5A, the touch display 120 displays a first menu P1 corresponding to the user interface 111. When the touch display 120 receives a touch operation of a user’s finger 501 (or stylus) on the first menu P1, the processor 130 may switch the touch display 120 to display a slider as shown in FIG. 5B, and display a second menu P2 in the user interface 111 through the display 110. The first menu P1 may include a plurality of first menu icons, and the touch operation at this time is a tap touch operation, and is used to select one of the plurality of first menu icons. The first menu P1 may include, for example, a drawing function menu of a plurality of drawing function icons.

Moreover, the display 110 and the touch display 120 may synchronously display an extended color block 123, wherein the extended color block 123 connects the slider 122 and the second menu P2. Moreover, when the touch display 120 receives a touch operation of the user’s finger 501 on the slider 122, the slider 122 and the extended color block 123 are moved. The second menu P2 may include a plurality of second menu icons, and the touch operation at this time is a sliding touch operation, wherein the slider and the extended color block 123 move with the sliding touch operation to selectively point to one of the plurality of second menu icons in the second menu P2. The second menu P2 may include, for example, a drawing tool menu of a plurality of drawing tool icons.

It should be noted that the extended color block 123 is a result of combining a first section color block C1 displayed by the display 110 and a second section color block C2 displayed by the touch display 120, and is used to a correspondence result between a position of the slider 122 and one of the plurality of second menu icons in the second menu P2. The extended color block 123 may be a solid color block and/or a translucent color block.

When the touch display 120 receives a touch operation of the user’s finger 501 on the slider 122, the processor 130 may switch to display a third menu P3 and adjustable content B1 as shown in FIG. 5C in the user interface 111 through the display 110, and the display 110 and the touch display 120 may continue to synchronously display the extended color block 123, wherein the extended color block 123 connects the slider 122 and the third menu P3. The touch operation at this time is a tap touch operation, and is used to select one of the plurality of second menu icons. In addition, the adjustable content B1 may be, for example, an adjustable object (such as a graphic object) in drawing software, but the invention is not limited thereto. The adjustable content B1 may be an original screen object in the user interface 111.

When the touch display 120 receives a touch operation of the user’s finger 501 on the slider 122, the slider 122 and the extended color block 123 are moved. The third menu P3 includes a plurality of third menu icons, and the touch operation at this time is a sliding touch operation. The slider 122 and the extended color block 123 move with the sliding touch operation to selectively point to one of the plurality of third menu icons. The third menu P3 may include, for example, a drawing parameter setting menu of a plurality of drawing adjustment parameter icons.

As shown in FIG. 5D, when the touch display 120 receives a touch operation of the user’s finger 501 on the slider 122, the processor 130 may determine adjustable content B2 in the user interface 111, wherein the touch operation at this time is a tap touch operation. And when the touch display 120 receives a touch operation of the user’s finger 501 on the slider 122, the adjustable content B2 is correspondingly changed, wherein the touch operation at this time is a sliding touch operation.

When the touch display 120 receives a tap touch operation of the user’s finger 501 on the slider 122, as shown in FIG. 5E, the processor 130 may fix an adjustment result of the adjustable content B3, and the touch display 120 will switch to display the first menu P1. In addition, in FIGS. 5B - 5D, the touch display 120 may further display the return diagram 121. Moreover, when the touch display 120 receives a tap touch operation on the return diagram 121, the touch display 120 may return to display a previous screen.

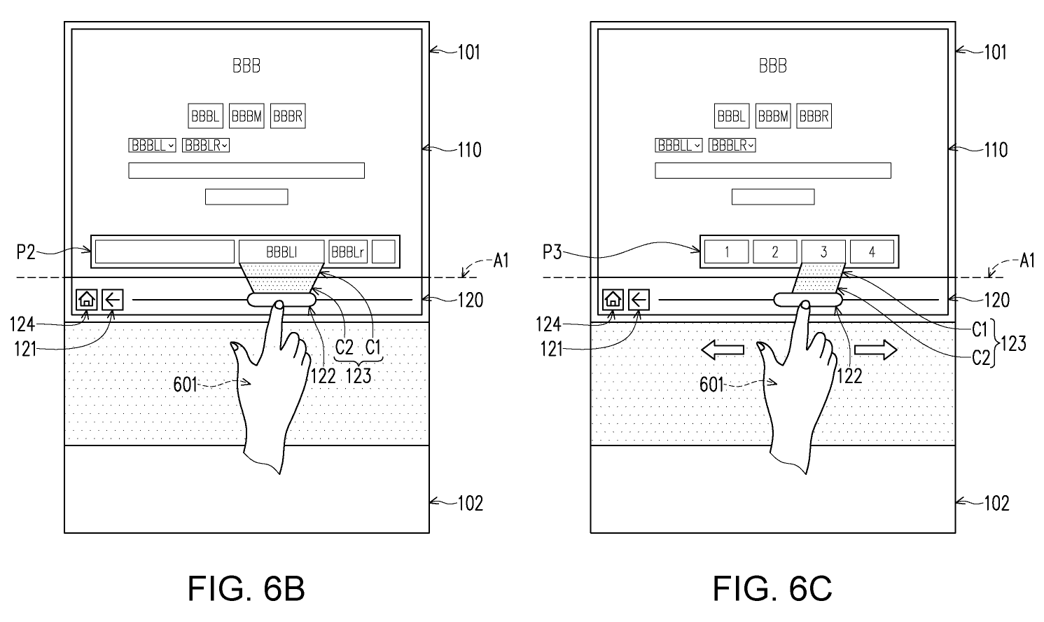

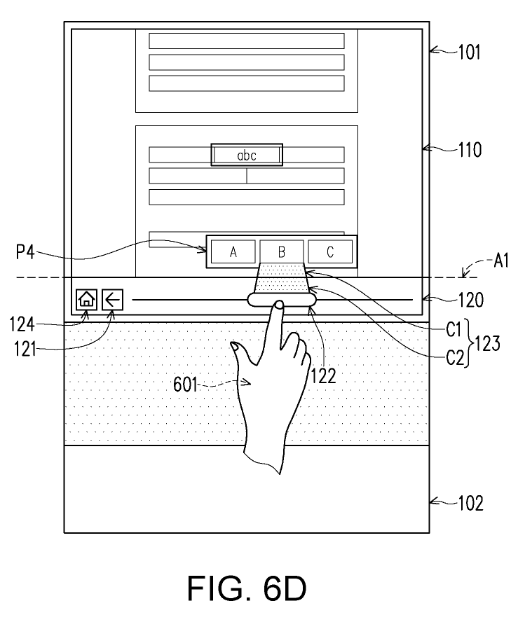

FIGS. 6A - 6D are a plurality of operation schematic diagrams of an electronic device according to another embodiment of the invention. For another example, referring to FIGS. 1 and 6B - 6D, the display 110 may display the user interface 111, and the touch display 120 may display an operation assistance interface. In the embodiment, the user interface 111 may be, for example, an operation page of an artificial intelligence module. In FIG. 6A, the touch display 120 displays the first menu P1 corresponding to the user interface 111. The first menu P1 may include, for example, a plurality of first menu icons of “AAA”, “BBB”, and “CCC”. When the touch display 120 receives a touch operation of the user's finger 601 on the first menu P1 (for example, selecting the first menu icon “BBB”), the processor 130 may switch the touch display 120 to display a slider as shown in FIG. 6B, and display the second menu P2 in the user interface 111 through the display 110. The touch operation at this time is a tap touch operation and is used to select one of the plurality of first menu icons.

Moreover, the display 110 and the touch display 120 may synchronously display the extended color block 123, wherein the extended color block 123 connects the slider 122 and the second menu P2. And when the touch display 120 receives a touch operation of the user’s finger 601 on the slider 122, the slider 122 and the extended color block 123 are moved. The second menu P2 may be an adjustment window, and the adjustment window includes a plurality of adjustment menus corresponding to adjustable content. The second menu P2 may include, for example, adjustment menus of “BBBLl” and “BBBLr”, and corresponds to adjustable content of “BBBLL” and “BBBLR” in a current page. The extended color block 123 may connect the slider 122 and one of the plurality of adjustment menus. Moreover, the touch operation at this time is a sliding touch operation, wherein the slider and the extended color block 123 move with the sliding touch operation to selectively point to one of the plurality of adjustment menus in the second menu P2.

For example, the first menu P1 may include a plurality of operation function icons of related artificial intelligence modules such as “paste text”, “generate presentation”, or “input file”. The second menu P2 may include a plurality of operation function icons related to “generate presentation” such as “input text window”, “presentation page count”, or “language”. Moreover, during the operation process, the user may also use the keyboard module or mouse to input text or select operations such as page count and language.

When the touch display 120 receives a click touch operation of the user’s finger 601 on the slider 122, the processor 130 may switch to display the third menu P3 as shown in FIG. 6C in the user interface 111 through the display 110, and the display 110 and the touch display 120 may continue to synchronously display the extended color block 123. Moreover, the touch operation at this time is a click touch operation, and is used to select one of the plurality of adjustment menus. The third menu P3 may be a next-level adjustment window, and includes a plurality of adjustment menus corresponding to adjustable content. The extended color block 123 may connect the slider 122 and one of the plurality of adjustment menus.

The third menu P3 may include, for example, a plurality of page count icons of page numbers. When the touch display 120 receives a touch operation of the user’s finger 601 on the slider 122, the slider 122 and the extended color block 123 are moved. The third menu P3 includes a plurality of adjustment menus, and the touch operation at this time is a sliding touch operation. The slider 122 and the extended color block 123 move with the sliding touch operation to selectively point to one of the plurality of adjustment menus in the third menu P3.

When the touch display 120 receives a touch operation of the user’s finger 601 on the slider 122, the processor 130 may switch to display the fourth menu P4 as shown in FIG. 6D in the user interface 111 through the display 110, and the display 110 and the touch display 120 may continue to synchronously display the extended color block 123. Moreover, the touch operation at this time is a click touch operation, and is used to select one of the plurality of adjustment menus. The fourth menu P4 may be a further next-level adjustment window, and includes a plurality of adjustment menus corresponding to adjustable content. The fourth menu P4 may include, for example, a plurality of font size selection icons “A”, “B”, and “C” for selecting font size, and is used, for example, to adjust the font size of “abc” in the current page. The extended color block 123 may connect the slider 122 and one of the plurality of adjustment menus.

When the touch display 120 receives a touch operation of the user’s finger 601 on the slider 122, the slider 122 and the extended color block 123 are moved. Moreover, the touch operation at this time is a sliding touch operation. The slider 122 and the extended color block 123 move with the sliding touch operation to selectively point to one of the plurality of adjustment menus in the fourth menu P4.

When the touch display 120 receives a click touch operation of the user’s finger 601 on the slider 122, the processor 130 may confirm the selection result of the adjustment menu, and allow an artificial intelligence module to execute, for example, corresponding functions, operations, or module settings, and the invention is not limited thereto.

Additionally, in FIGS. 6A - 6D, the touch display 120 may further display the home page diagram 124. Moreover, when the touch display 120 receives a click touch operation on the home page diagram 124, the touch display 120 may switch to display the first menu P1. In FIGS. 6B - 6D, the touch display 120 may further display the return diagram 121. Moreover, when the touch display 120 receives a click touch operation on the return diagram 121, the touch display 120 may return to display the previous screen.

In summary, the electronic device and the operating method thereof of the invention may provide good operation assistance functions through the touch display, and are particularly helpful for users to achieve menu operations in the user interface and/or adjustment operations of specific application functions through touch operations on the touch display. Moreover, the electronic device and the operating method thereof of the embodiment may achieve highly directional display prompt functions through the design of the extended color block, thereby allowing users to quickly grasp cross-screen operation logic and effectively enhance user experience.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An operation method of an electronic device, comprising:
displaying a user interface through a display of the electronic device;
displaying a first menu corresponding to the user interface through a touch display of the electronic device;
in response to receiving a first touch operation on the first menu by the touch display, switching the touch display to display a slider, displaying a second menu in the user interface through the display, and synchronously displaying a first extended color block through the display and the touch display, wherein the first extended color block connects the slider and the second menu; and
in response to receiving a second touch operation on the slider by the touch display, moving the slider and the first extended color block.

2. The operation method of the electronic device according to claim 1, wherein the first menu comprises a plurality of first menu icons, and the first touch operation is a first click touch operation, wherein the first click touch operation is configured to select one of the first menu icons.

3. The operation method of the electronic device according to claim 1, wherein the second menu comprises a plurality of second menu icons, and the second touch operation is a first sliding touch operation, wherein the slider and the first extended color block move with the first sliding touch operation to selectively point one of the second menu icons.

4. The operation method of the electronic device according to claim 3, further comprising:
in response to receiving a third touch operation on the slider by the touch display, switching to display a third menu in the user interface through the display, and synchronously displaying a second extended color block through the display and the touch display, wherein the second extended color block connects the slider and the third menu; and
in response to receiving a fourth touch operation on the slider by the touch display, moving the slider and the second extended color block.

5. The operation method of the electronic device according to claim 4, wherein the third touch operation is a second click touch operation, and the second click touch operation is configured to select one of the second menu icons.

6. The operation method of the electronic device according to claim 4, wherein the third menu comprises a plurality of third menu icons, and the fourth touch operation is a second sliding touch operation, wherein the slider and the second extended color block move with the second sliding touch operation to selectively point one of the third menu icons.

7. The operation method of the electronic device according to claim 3, further comprising:
in response to receiving a fifth touch operation on the slider by the touch display, determining an adjustable content in the user interface; and
in response to receiving a sixth touch operation on the slider by the touch display, causing the adjustable content to correspondingly change.

8. The operation method of the electronic device according to claim 7, wherein the fifth touch operation is a third click touch operation, and the sixth touch operation is a third sliding touch operation.

9. The operation method of the electronic device according to claim 7, wherein the adjustable content is an original screen object in the user interface.

10. The operation method of the electronic device according to claim 7, wherein the second menu is an adjustment window, and the adjustment window comprises a plurality of adjustment menus corresponding to the adjustable content.

11. The operation method of the electronic device according to claim 10, further comprising:
in response to receiving the second touch operation on the slider by the touch display, further synchronously displaying a third extended color block through the display and the touch display, wherein the third extended color block connects the slider and one of the adjustment menus.

12. The operation method of the electronic device according to claim 11, further comprising:
in response to receiving a fourth click touch operation on the slider by the touch display, confirming a selection result of one of the adjustment menus.

13. The operation method of the electronic device according to claim 1, wherein the touch display further displays a return diagram, and the method further comprises:
in response to receiving a fifth click touch operation on the return diagram by the touch display, returning the touch display to display a previous screen.

14. The operation method of the electronic device according to claim 1, wherein the touch display further displays a home page diagram, and the method further comprises:
in response to receiving a sixth click touch operation on the home page diagram by the touch display, switching the touch display to display the first menu.

15. The operation method of the electronic device according to claim 1, wherein the first extended color block is a solid color block.

16. The operation method of the electronic device according to claim 1, wherein the first extended color block is a translucent color block.

17. The operation method of the electronic device according to claim 1, wherein the user interface is a drawing software work page.

18. The operation method of the electronic device according to claim 1, wherein the user interface is an operation page of an artificial intelligence module.

19. The operation method of the electronic device according to claim 1, wherein the electronic device is a laptop,
wherein the display and the touch display are respectively disposed on different bodies of the laptop, and the display and the touch display are adjacent to each other.

20. An electronic device, comprising:
a first body having a display;
a second body connected to the first body through a rotatable shaft component and having a touch display, wherein the display and the touch display are adjacent to each other; and
a processor coupled to the display and the touch display, wherein the processor is configured to perform following operations:
displaying a user interface through the display;
displaying a first menu corresponding to the user interface through the touch display;
in response to receiving a first touch operation on the first menu by the touch display, switching the touch display to display a slider, displaying a second menu in the user interface through the display, and synchronously displaying a first extended color block through the display and the touch display, wherein the first extended color block connects the slider and the second menu; and
in response to receiving a second touch operation on the slider by the touch display, moving the slider and the first extended color block.
